(19) United States
(12) Patent Application Publication
(10) Pub. No.: US 2021/0105981 A1
(43) Pub. Date: Apr. 15, 2021

(54) MOLLUSK FARMING DEVICE AND METHOD

(71) Applicant: SEADELICIOUS, VERINES (FR)

(72) Inventors: Jérôme, Marc, Philippe BOSMANS, POUSSAN (FR); François-Eric VAUCHEZ, VERINES (FR)

(21) Appl. No.: 16/603,619

(22) PCT Filed: May 23, 2018
(86) PCT No.: PCT/EP2018/063462

§ 371 Date: Oct. 8, 2019

(30) Foreign Application Priority Data
May 24, 2017 (FR) 1754602

(51) Int. Cl. A01K 61/55; A01K 61/65

(52) U.S. Cl. CPC A01K 61/55; A01K 61/65

(57) ABSTRACT

An oyster farming device comprising containers configured to contain oysters and linked to at least one ballast. The device comprises a horizontal pivot axis, parallel to a longitudinal direction, and at least two rigid arms that ling the pivot axis and the ballast, parallel to the longitudinal direction, such that the filling or emptying of the ballast causes the arm to rotate about the pivot axis and results in the emergence and rolling of the oysters in the containers.

### CROSS-REFERENCES TO RELATED APPLICATIONS

This application claims the benefit of the International Application No. PCT/EP2018/063462, filed on May 23, 2018, and of the French patent application No. 1754602 filed on May 24, 2017, the entire disclosures of which are incorporated herein by way of reference.

### FIELD OF THE INVENTION

The present application relates to a device and to a method for farming mollusks, more particularly suited to the farming of oysters.

### BACKGROUND OF THE INVENTION

According to one farming technique, the oysters are placed in plastic mesh bags which are arranged on raised structures known as tables.

These raised structures are carefully positioned on the foreshore so that the oysters are subjected to a phenomenon of exposure as a result of the tides.

During this farming phase, the bags are regularly turned and cleaned so that the oysters can grow under good conditions and develop even shapes. These operations of turning the bags are not mechanized and are performed by hand They are lengthy and painstaking.

After a period, the length of which varies according to their growth and according to the desired organoleptic qualities thereof, the oysters are taken out of the water, the spat is removed, and the oysters are cleaned and sorted according to their size categories.

In certain production zones, after this phase of foreshore farming, the mature oysters are refined in refining basins known as claires, which are permanently submerged for a period the length of which varies (from a few weeks to several months) to improve their organoleptic qualities, the size of their shell and the color of their flesh.

This farming technique is not entirely satisfactory. Specifically, the production zone on the foreshore is not a zone that is safe from a hygiene standpoint. Thus, oyster production may be affected by environmental factors such as pollution or disease.

In order to overcome this problem, one solution is to farm the oysters in a closed or semi-closed environment, made up of claires, in order the better to control the nutritional characteristics and the hygiene aspect. However, it is necessary, in order to ensure optimum shell growth and muscle development of the oysters, for them to be subjected to a phenomenon of exposure and of tumbling (or rolling), reproducing the effects of the tide. Because the water level is constant, the oysters need to be moved back and forth and vertically.

Document EP1679958 describes a mollusk farming system comprising four cylindrical and vertical ballasts which support a chassis made up amongst other things of vertical perforated walls which form an open frame inside which there are positioned superposed farming surfaces on which the mollusks are placed. By controlling the emptying and the filling of the ballasts, it is possible to immerse the farming surfaces to greater or lesser extents.

Even though this farming system may be suitable for bringing about a phenomenon of exposure, it can work only with a significant head of water offshore, and this means that the nutritional characteristics and the hygiene conditions of the production environment cannot be controlled.

Another disadvantage is that such a farming system does not make it possible to stimulate the oysters to develop a thicker shell and more muscle because there is no phenomenon of tumbling and of rolling.

Finally, this farming system does not make it possible to obtain uniform oyster growth. Specifically, the oysters are not regularly turned and tumbled as they are when packed in bags that are turned regularly.

Document FR2576484 describes a mollusk farming device which comprises a cage, with mesh walls, pivot mounted about a fixed axle and provided with a float. Due to the float, the cage pivots about the fixed axle according to the height of water. This type of device does not make it possible to achieve effective rolling because the rise of the water level is very slow and associated with the tide. In addition, this action cannot be controlled and replicated outside of the periods of tidal movement, namely at most four times per day.

### SUMMARY OF THE INVENTION

The present invention seeks to overcome the disadvantages of the prior art.

To this end, one subject of the invention is a device for farming oysters, comprising containers configured to contain oysters and connected to at least one ballast. According to the invention, the device comprises a pivot axle which is horizontal, parallel to a longitudinal direction, and at least two rigid arms which connect the ballast, parallel to the longitudinal direction, and the pivot axle so that a filling or emptying of the ballast causes the arm to rotate about the pivot axle and causes a phenomenon of rolling of the oysters in the containers.

The repeated phenomenon of rolling makes the oyster shells smoother and rids them of shell fringes and makes it possible to obtain more uniform growth with a better length/width/thickness ratio. Another advantage is that it eliminates the painstaking operations of turning and spat detachment. The stress induced by the phenomenon of rolling, combined with a phenomenon of exposure, strengthens the muscle of the oyster and contributes to the oysters developing a thicker shell with whiter and brighter pearl. It also means that the stimulated and stressed oysters put on more reserves also improving their flesh content and organoleptic qualities.

According to one configuration, the oyster farming device comprises two ballasts arranged on either side of the pivot axle and connected by arms thereto. This configuration makes it possible to balance the loads on the pivot axle and optimize its use.

According to another feature, the pivot axle is able to float. This solution is more particularly suited to production zones with heads of water that vary notably on account of the tides.

According to the alternative forms, the pivot axle slides along posts anchored to the seabed or is connected by flexible connecting elements to deadweights placed on the seabed.

Another subject of the invention is a method for farming oysters packed in containers connected to at least one ballast, which is oriented in a longitudinal direction, able to move between a high position and a low position during a filling or an emptying of the ballast. The method is characterized in that the ballast pivots about a pivot axle, parallel to the longitudinal direction, in order to generate a phenomenon of rolling.

According to another feature, the containers are out of the water when positioned in the high position in order to generate a phenomenon of exposure.

### BRIEF DESCRIPTION OF THE DRAWINGS

Further features and advantages will become apparent from the description of the invention which will follow, which description is given solely by way of example, with reference to the attached drawings in which:

FIG. 1 is a perspective view of an oyster farming installation which illustrates a first embodiment of the invention,

FIG. 2 is a perspective view of an oyster farming device illustrating the first embodiment,

FIG. 3 is a view of details of the oyster farming device visible in FIG. 1,

FIGS. 4A to 4C are cross sections illustrating various modes of operation of an oyster farming device,

FIGS. 5 and 6 are cross sections through an oyster farming device in various positions, illustrating a phenomenon of rolling of the oysters, and

FIGS. 7 and 8 are cross sections of a ballast, respectively in the floating position and in the submerged position, illustrating another embodiment of the invention,

FIG. 9 is a perspective view of part of an oyster farming device illustrating one embodiment of the invention,

FIGS. 10 and 11 are diagrams illustrating one embodiment of the fixings of the containers in the floating and in the submerged positions respectively,

FIG. 12 is a diagram illustrating another embodiment of the fixings of the containers in the floating position,

FIGS. 13 and 14 are diagrams illustrating another embodiment of the fixings of the containers in the floating and submerged positions respectively,

FIG. 15 is a perspective view of part of an oyster farming device illustrating another embodiment of the invention,

FIGS. 16 and 17 are sections through an oyster container illustrating various alternative forms of the invention, and

FIGS. 18A and 18B are sections through part of an oyster farming device illustrating another embodiment, respectively in the high position and during the process of submerging.

### DETAILED DESCRIPTION OF THE PREFERRED EMBODIMENTS

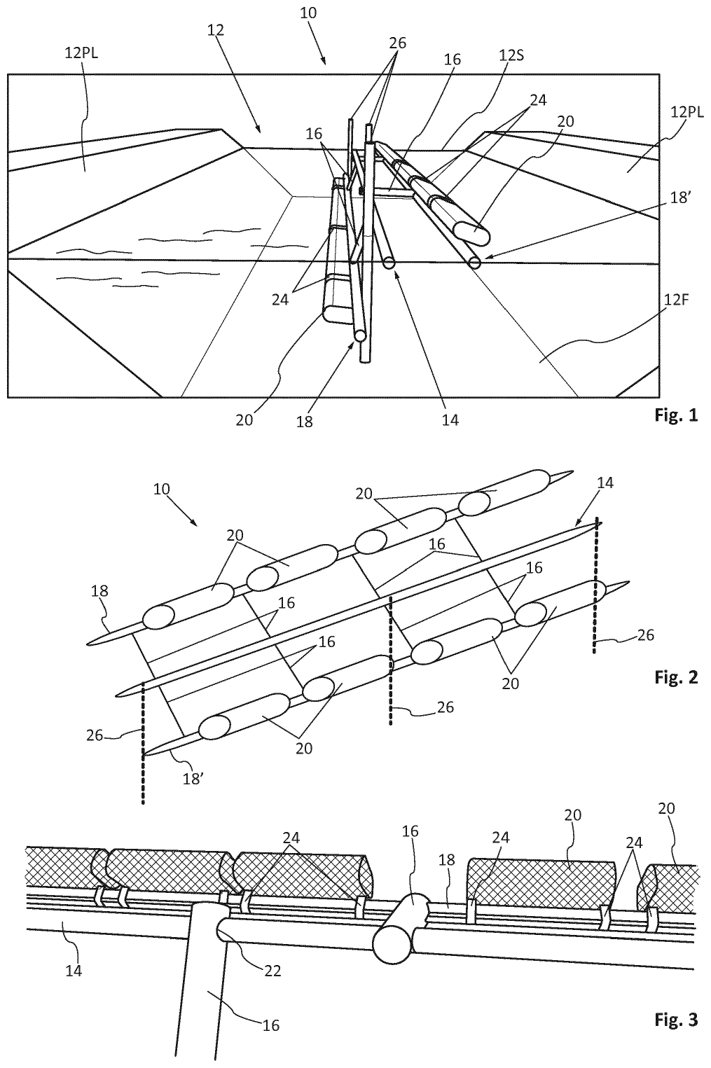

In FIG. 1, an oyster farming installation 10 is positioned in a closed farming basin 12, such as a claire of a marsh, for example. According to other examples, the invention may be employed in a lake, in an onshore basin (closed aquaculture circuit), a lagoon or any other fairly closed and sheltered expanse of water. This solution allows better control of the characteristics of the aquatic environment in which the oysters are produced and ultimately makes it possible to limit hygiene risks.

This farming basin 12 comprises a bottom 12F and side walls 12PL. To give an idea of scale, the surface of the water 12S is situated at a height of the order of 1 to 2 m above the bottom 12F.

The invention is not in any way restricted to oysters and could be used for farming other mollusks. In addition, the farming installation 10 could be installed on a site out to sea.

An oyster farming installation 10 comprises at least one oyster farming device which comprises:

a horizontal pivot axle 14 which is parallel to a longitudinal direction,

at least two rigid arms 16 which extend in a direction perpendicular to the longitudinal direction,

at least one ballast 18 which extends in a direction parallel to the longitudinal direction, connected to the pivot axle 14 by the arms 16, said ballast 18 being able to move between positions that are submerged to greater or lesser extents according to its degree of filling with water and with air,

at least one container 20 configured to contain oysters and fixed to the ballast 18.

According to one embodiment, each container 20 is a perforated basket made of high density polyethylene HDPE in order to give it rigidity. By way of example, each container has a length of between 0.5 m and 2 m. Each container is sized and filled with oysters in such a way as to be able to be handled and carried by one person at the end of the farming phase.

The cross section may be circular, oval or oblong. For preference, the cross section of the container has a curved closed profile to encourage a phenomenon of rolling specified later. In the case of a non-circular cross section, the longest dimension of the cross section may be oriented vertically when the ballast 18 is in the high position, so as to encourage the phenomenon of rolling.

The ballast 18 has a longilinear shape which extends in the longitudinal direction. The ballast 18 is a tube, as illustrated in FIGS. 5 and 6. The diameter of the tube that forms the ballast 18 is dependent notably on the weight of the container 20 when it is full of oysters. By way of indication, the tube has a diameter of the order of around ten centimeters. To give an idea of scale, each ballast 18 has a diameter of around 200 mm According to another embodiment, each ballast 18 is a tube that is holed or slit along its length (parallel to the longitudinal direction), as illustrated in FIGS. 7 and 8.

The ballast 18 may be made of high density polyethylene HDPE.

The ballast 18 may comprise one or more fluid tight portions that cannot communicate with one another. Each portion has a length comprised between 1 and 50 m. For preference, each portion has a length less than or equal to 5 m in order to obtain a uniform distribution of the air in the portion along the entire length thereof at the time of filling of the ballast.

According to one layout and nonlimitingly, the arms 16 are arranged between two or three adjacent containers 20. Arms 16 may also be positioned at each end of the ballast 18.

The arms 16 allow the rising and falling movement of the ballasts 18 to be converted into a movement of rotation about the pivot axle 14 following the filling and emptying of the ballasts 18.

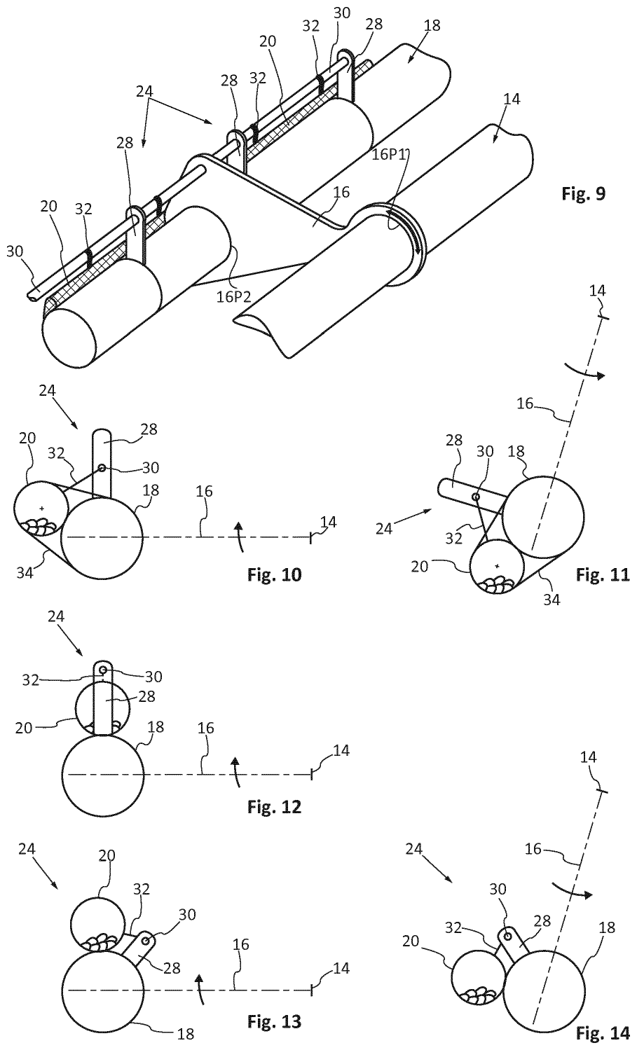

Each arm 16 at a first end comprises a rigid connection to the ballast 18 and at a second end comprises a pivoting connection to the pivot axle 14, as illustrated in detail in FIG. 9.

As an alternative, the arm 16 is connected to the ballast 18 by a pivoting connection like for the pivot axle 14.

According to one embodiment visible in FIG. 3, each arm 16 is a rigid tube which, at its end connected to the pivot axle 14, comprises a transverse hole 22 (perpendicular to the axis of the tube) in which the pivot axle 14 pivots.

According to another embodiment visible in FIG. 9, each arm 16 takes the form of a plate arranged in a plane perpendicular to the pivot axle 14 and which comprises a passage hole 16P1 through which the pivot axle 14 passes, the arm 16 being able to pivot freely with respect to the pivot axle 14. In this embodiment, the arm 16 comprises a passage hole 16P2 through which the ballast 18 passes, the arm 16 and the ballast 18 being connected by a rigid or pivoting connection.

By way of example, each arm 16 is made of high density polyethylene HDPE.

Of course, the invention is not restricted to this embodiment. Other solutions for the arm 16 and for the connections between the arm 16 and the ballast 18 and between the arm 16 and the pivot axle 14 are conceivable.

As illustrated in FIGS. 5 and 6, due to the arm 16, the ballast 18 moves between a low position P1, situated substantially in vertical alignment with and below the pivot axle 14, and a high position P3, which is offset with respect to the pivot axle 14 and substantially in the same horizontal plane as the pivot axle 14. According to the configuration illustrated in FIGS. 5 and 6, each arm 16 effects a rotational movement, about the pivot axle 14, of almost a quarter of a revolution. In order for the ballasts to descend as far as possible without knocking against one another at the end of their travel, the arms 16 arranged on either side of the pivot axle 14 do not have the same length.

Of course, the invention is not restricted to this configuration. Thus, the rotation of the arm 16 about the pivot axle 14 may be greater than or less than one quarter of a revolution. Likewise, it is possible for the ballast 18 not to be vertically in line with the pivot axle in the low position and/or it is possible for the ballast 18 to be offset heightwise with respect to the pivot axle 14 in the high position. The pivot axle 14 may be submerged by a certain depth in order to increase the amplitude of the rotational movement of the arm 16 and therefore the amplitude of the phenomenon of rolling.

Each ballast 18 supports several containers 20 distributed along the length of the ballast 18.

Each container 20 is connected to the ballast by at least one connection 24 which is unfastenable so that each container 20 can be detached so that it can be transferred to an oyster sorting and packing zone.

According to one embodiment, one same container 20 is connected directly or indirectly to one of the ballasts 18 by at least two connections 24, for example positioned near each of the ends of the container 20.

According to one embodiment visible in FIGS. 5 and 6, each connection 24 is configured to keep each container 20 immobile with respect to the ballast 18 to which it is attached. For preference, the container 20 is attached to the ballast 18 in such a way as to be positioned above the ballast 18 when the latter is situated at the surface of the water. Thus, each container 20 is placed on the side of the ballast 18 when the latter is in the low position P1 and above the ballast 18 when the latter is in the high position P3. Of course, the invention is not restricted to this positioning of the container 20 with respect to the ballast 18. Thus, in the high position P3, the container 20 may be offset with respect to the vertical, the straight line passing through the centers of the container and of the ballast forming, for example, an angle of 45° with the horizontal direction.

According to other embodiments that can be seen in FIGS. 9 to 14, the containers 20 are not directly connected to the ballast 18 and are able to move with respect thereto.

According to one embodiment visible in FIGS. 9 to 14, the connection 24 between at least one container 20 and a ballast 18 comprises:

at least two lugs 28, each arranged in a plane perpendicular to the longitudinal direction and having an end which is rigidly connected to the ballast 18, and

a rod 30, supported by the lugs 28, which extends in a direction parallel to the longitudinal direction.

With this configuration, each container 20 is connected to one of the rods 30 by flexible or rigid ties 32, in a fixed or pendular position.

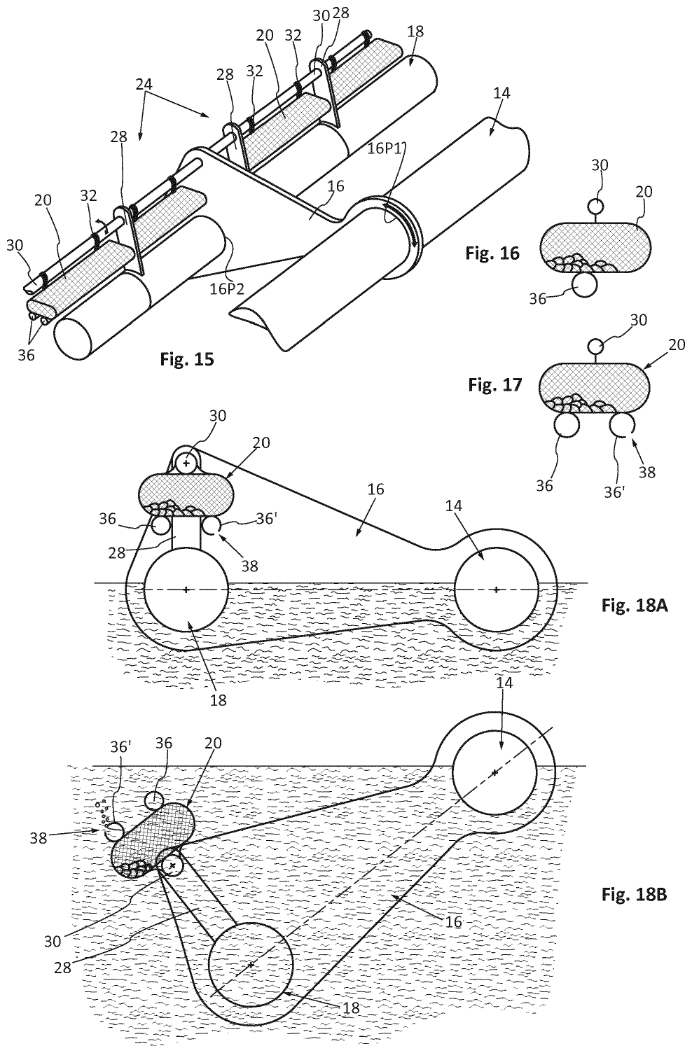

According to one embodiment visible in FIGS. 9 and 15, the rods 30 are also supported by the arms 16. According to a first alternative form, each ballast 18 is associated with a single rod 30 which extends parallel to the ballast 18 over practically the entire length thereof and which passes through the arms 16. As an alternative, each ballast 18 is associated with several rods the ends of which are connected to the arms 16. With this embodiment, if the rods 30 were rigid enough, the lugs 28 would be able to be omitted.

According to the embodiment visible in FIGS. 9 and 15, the containers 20 are not connected to the ballast(s) 18 directly but indirectly via the arms 16 and/or the lugs 28.

For preference, the farming device comprises:

at least one first pivot axle 14,

at least one second pivot axle, either the ballast 18, or the rod 30, connected to the first pivot axle 14 and configured to pivot about the first pivot axle 14 according to the filling or the emptying of the ballast 18,

at least one container 20 connected to the second pivot axle about which it can pivot freely.

Thus, the movement of pivoting about the first pivot axle 14 makes it possible to obtain the phenomenon of exposure while the combination of the two movements of pivoting about the first and second pivot axles makes it possible to obtain a more effective rolling phenomenon.

The container 20 may be connected to the ballast 18 by a tie 34 to prevent it from becoming detached from the ballast 18 in the low position, as illustrated in FIGS. 10 and 11.

Depending on the distance between the ballast 18 and the rod 30, the container 20 may be higher or not as high in the high position, as illustrated in FIGS. 10 and 12.

It is possible to alter the height of the container 20 by altering the length of the ties or by altering the angular position of the lugs 28 with respect to the arm 16, as illustrated in FIGS. 13 and 14.

Whatever the embodiment of the connection between the container and the ballast, each container 20 needs to be at least partially out of the water, and preferably completely out of the water, in order to obtain a phenomenon of exposure when the ballast is in the high position P3.

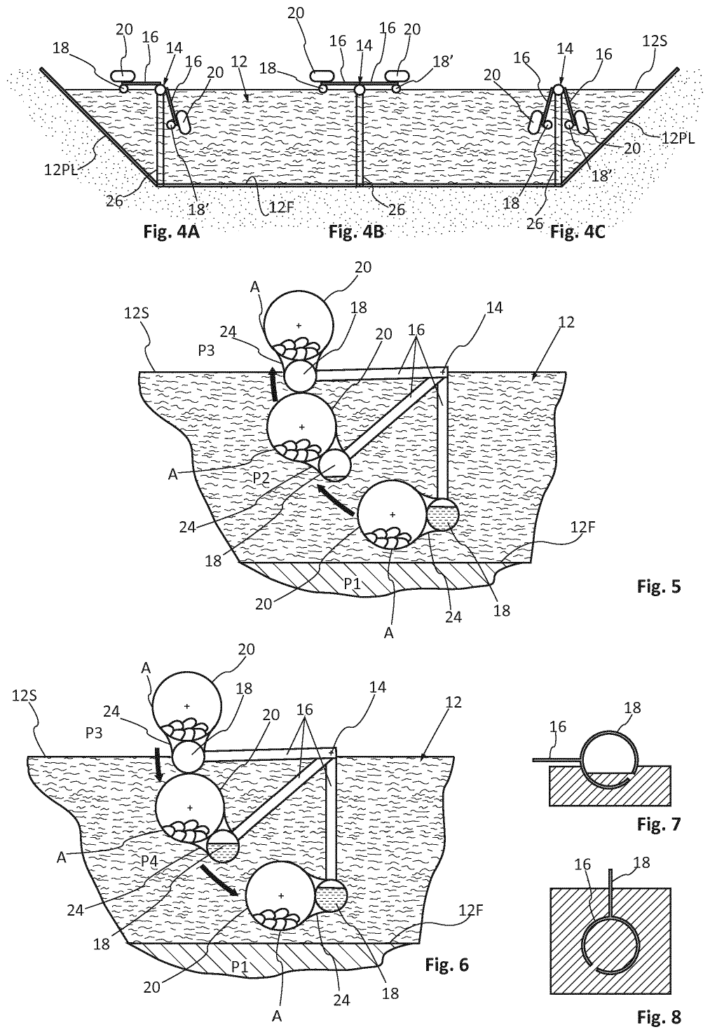

Whatever the embodiment of the connections 24, the containers 20 may be positioned in the high position either to the side of the ballast 18 as illustrated in FIGS. 1, 3, 9 and 10, or above the ballast 18, as illustrated in FIGS. 4A to 4C, 5, 6, 12 and 13.

According to one embodiment, the farming device comprises several fixed vertical stakes 26, embedded in the bottom 12F of the farming basin and arranged in a staggered configuration on either side of the pivot axle 14 in order to immobilize it horizontally and allow it to rise and fall.

According to a first alternative form visible in FIG. 4, the pivot axle 14 is positioned at a constant height above the bottom 12F. In this case, the pivot axle 14 is connected to the stakes 26 so as to be immobile on the surface of the water. This first alternative form is suitable when the height of water is substantially constant.

According to a second alternative form visible in FIG. 1, the pivot axle is able to float. It is immobilized in a direction perpendicular to the longitudinal direction. By way of example and nonlimitingly, the pivot axle 14 is immobilized with respect to the stakes 26 in such a way as to be able to slide along the height of the stakes 26. Thus, with this second alternative form, the pivot axle 14 is always positioned at the surface of the water. This second alternative form is better suited to production zones with heights of water that vary notably as a result of tidal activity or because of the fill level of the claires.

According to a third alternative form, the pivot axle 14 is connected to the stakes 26 in such a way as to be always kept submerged, at a constant depth, in order to increase the amplitude of rotation of the arms 16.

According to another embodiment, at least one deadweight is connected to the pivot axle 14 by a line passing through a loop or pulley system positioned below the pivot axle 14 and ending in a counterweight, thus making it possible always to have the pivot axle 14 in a position perfectly vertically in line with the counterweight.

According to one embodiment, the pivot axle 14 is a tube (for example made of high density polyethylene HDPE) closed at its ends in a fluid tight manner and filled with air. To give an idea of scale, the pivot axle 14 has a diameter of around 150 mm There are other conceivable solutions for obtaining a pivot axle 14 that is able to float.

According to one preferred configuration, a farming device comprises a pivot axle 14 and two ballasts 18, 18′ arranged on either side of the pivot axle 14 and connected by arms 16 to the pivot axle 14. Thus, for each pivot axle 14, the farming zone is split into two half-spaces situated one on each side of a vertical plane passing through the pivot axle 14, a first ballast 18 being able to move in a first half-space and a second ballast 18′ being able to move in a second half-space.

This configuration makes it possible to reduce the number of pivot axles 14.

The movements of the ballasts 18, 18′ may be synchronous, as illustrated in FIGS. 4B and 4C, or non-synchronous, as illustrated in FIG. 4A.

In order to bring about the filling and/or the emptying of the ballasts, the installation 10 comprises at least one pressurized-air supply system, such as an automatic controller, electrically operated valves, a compressor or booster pump, and an air network for connecting the various ballasts 18, 18′ to the pressurized-air supply system.

For preference, the installation comprises an automatic controller for controlling the phases of filling and emptying the various ballasts.

Advantageously, the system for supplying pressurized air to the ballasts 18, 18′ is reversible and allows the ballasts 18, 18′ to be filled with air, during the rising phase, and allows the air present in the ballasts 18, 18′ to be sucked out, during the falling phase. This configuration makes it possible to have better control over the speed at which the ballasts rise and fall.

The principle of operation of the farming device is now described with reference to FIGS. 4A to 4C, 5 and 6.

When the ballast 18 is full of water, the weight of the containers 20 connected to the ballast 18 causes the ballast to move and become immobilized in the low position P1, and the containers and the oysters are in the submerged position. In order to raise the containers 20 back up to the high position P3, air is injected into the ballast 18. As the water is gradually removed, expelled by the pressurized air, the ballast 18 rises to the surface of the water, passing progressively through positions P1, P2 to P3. In the high position P3, the containers 20 and the oysters are situated out of the water. When the ballast 18 is no longer being supplied with pressurized air, the air escapes via an open electrically operated valve, and the ballast 18 progressively sinks, passing through positions P3, P4 to P1.

According to the invention, during the downward or upward movement, the containers 20 effect a movement of rotation about the pivot axle 14. This rotational movement, combined with the curved shape of the containers, gives rise to a phenomenon of rolling as illustrated in FIGS. 5 and 6. When the rotational movement is upward, the oysters are encouraged to roll in a first direction. When the rotational movement is downward, the oysters are encouraged to roll in a second direction, the opposite of the first.

This phenomenon of rolling can be altered according to the length of the arms 16, the amplitude of the movement of the arms 16, the cross-sectional shape of the container, the rate at which the arms 16 pivot about the pivot axle 14 in the rising direction and in the falling direction.

For preference, all the arms connected to the one same ballast have the same length, greater than or equal to 0.5 m. Ideally, the arms each have a length of the order of 1 m. The longer the arm 16 the more the oysters will be rolled.

According to one mode of operation, the rotational speeds in the rising direction and in the falling direction are identical. As an alternative, they may be different so that the phenomenon of rolling in the first direction is different from the phenomenon of rolling in the second direction. By way of example, the rotational speeds in the rising direction and in the falling direction are of the order of 30 seconds for 1 m of height.

The daily durations of the phenomena of rolling and of exposure, and the frequency of these phenomena, will be adjusted to suit the desired oyster qualities.

By way of example, the oysters are in a submerged position, as illustrated in FIG. 4C, in a position out of the water in the exposed phase, as illustrated in FIG. 4B, and in a rolling phase, as illustrated in FIG. 4A, due to the rotational movements of the arms 16 about the pivot axle 14. For each pivot axle, the rotational movements of the arms of the two ballasts 18, 18′ may or may not be out of phase with one another.

The invention makes it possible to combine a phenomenon of exposure, which comprises lifting the oysters out of the water for a determined period of time by constantly inflating the ballasts 18, 18′, and a phenomenon of rolling which comprises making the oysters roll around in the container 20 due to the alternating inflation and emptying. The combination of these two phenomena makes it possible artificially and in a controlled manner to recreate the action of the waves, of the wind, of the current and of the tides in a closed farming basin and to reinforce this action. The phenomenon of rolling makes the shells of the oysters smoother and rids them of shell fringes. The stress induced by the phenomena of exposure and of rolling strengthens the muscle of the oyster and contributes to the oysters developing a thicker shell with whiter and brighter pearl. In addition to the improvement to the esthetic and organoleptic qualities of the oysters, this allows them to be transported and kept in the open air for longer periods because of their better “hermetic seal” capability.

The rigidity of the containers 20 and their oblong cross sections encourage the phenomenon of rolling.

The oyster farming technique according to the invention makes it possible to obtain more stable, more reliable and better controlled production with oysters of a consistent quality.

According to another aspect, the farming technique according to the invention makes it possible to dispense with the painstaking tasks of turning over the bags of oysters.

It also makes it possible to eliminate the phenomena known as bio-fouling whereby the oysters are afflicted externally with parasites, and this makes it possible to dispense with the cleaning and spat removal phases and to reduce the level of pitting and of infestation with barnacles and other mollusks on the shell of the oysters thus cultivated.

According to configurations visible in FIGS. 15 to 17, 18A and 18B, the device comprises, in addition to the ballasts 18, at least one float 36 secured to a container 20. Thus, each container 20 comprises at least one float 36. Each float 36 has the shape of a cylinder and extends parallel to the direction of the ballasts 18, 18′ over practically the entire length of the container 20 to which it is connected. The floats 36 are connected to the container by any appropriate means. Each float 36 is immobile with respect to the container 20 to which it is connected.

According to a configuration visible in FIG. 16, the container comprises a single float 36. This float 36 may be fluid tight and continuously full of air, as illustrated in FIG. 16, or may comprise at least one hole 38 allowing the float to become filled with or emptied of water at a rate that varies according to the cross section of the hole or holes 38.

According to configurations visible in FIGS. 15, 17, 18A and 18B, each container comprises at least two floats 36, 36′, preferably exactly two floats 36, 36′. According to one embodiment visible in FIG. 15, each container 20 comprises two floats 36, 36′ which are fluid tight and which are constantly full of air.

According to one embodiment visible in FIGS. 17, 18A and 18B, each container 20 comprises a first float 36 which is fluid tight and which is constantly full of air and a second float 36′ which comprises at least one hole 38 allowing the float to become filled with or emptied of water more or less quickly.

According to another embodiment (not depicted), each container 20 comprises two floats each of which comprises at least one hole.

According to the embodiment visible in FIGS. 17, 18A and 18B, each container 20 comprises, on each side of a plane passing through the second pivot axle (formed by the rod 30 or the ballast 18), a fluid tight first float 36 and a second float 36′ provided with at least one hole 38.

For each float provided with at least one hole 38, the cross section of the hole or holes 38 is adjusted in such a way as to control the time taken for the float 36′ to fill or to empty.

According to a principle of operation visible in FIGS. 18A and 18B, the cross section of the holes 38 is adjusted in such a way that the speed of filling of the float 36′ is not as rapid as that of the ballast 18.

This difference in fill rate makes it possible to encourage the rotational movement of the container 20 about the second pivot axle (the rod 30), thereby contributing to improving the phenomenon of rolling.

The act of providing a first float 36 that is fluid tight and constantly full of air and a second float 36 that is provided with at least one hole 38 makes it possible to obtain imbalance and initiate a movement of rotation about the second pivot axle.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-14. (canceled)

15. A device for farming mollusks, comprising containers configured to contain mollusks and connected to at least one ballast, comprising:
at least a first pivot axle which is horizontal, parallel to a longitudinal direction, and
at least two rigid arms which connect the ballast, parallel to the longitudinal direction, and the pivot axle so that a filling or emptying of the ballast with water causes the arm to rotate about the first pivot axle and causes a phenomenon of rolling of the mollusks in the containers.

16. The device as claimed in claim 15, further comprising at least a second pivot axle connected to the first pivot axle and configured to pivot about the first pivot axle according to the filling or the emptying of the ballast, at least one of the containers being connected to the second pivot axle about which the at least one container can pivot freely.

17. The device as claimed in claim 16, wherein each container comprises at least one float.

18. The device as claimed in claim 17, wherein each container comprises a fluid tight first float continuously full of air and a second float provided with at least one hole allowing the second float to fill with or empty of water at a rate dependent on a cross section of the hole.

19. The device as claimed in claim 18, wherein each container comprises, on each side of a plane passing through the second pivot axle, a fluid tight first float and a second float provided with at least one hole.

20. The device as claimed in claim 18, wherein the cross section of the at least one hole in each float is adjusted so that the rate of filling of the float is not as rapid as that of the ballast.

21. The device as claimed in claim 15, wherein each arm has a length greater than or equal to 0.5 m.

22. The device as claimed in claim 15, wherein each container comprises, in a plane perpendicular to the longitudinal direction, a cross section with a curved profile in order to encourage a phenomenon of rolling.

23. The device as claimed in claim 22, wherein the containers are rigid and have a circular, oval or oblong section.

24. The device as claimed in claim 15, further comprising two ballasts arranged on either side of the pivot axle and connected by arms to the first pivot axle.

25. The device as claimed in claim 15, wherein the first pivot axle is able to float and is immobilized in a direction perpendicular to the longitudinal direction.

26. A method for farming oysters using a farming device as claimed in claim 15, comprising the steps:
packing the oysters in containers connected to at least one ballast,
orienting the ballast in a longitudinal direction, movable between a high position and a low position during a filling or an emptying of the ballast, and
pivoting the ballast about a first pivot axle, parallel to the longitudinal direction, to generate a phenomenon of rolling.

27. The method as claimed in claim 26, wherein the containers are out of the water when positioned in the high position in order to generate a phenomenon of exposure.

28. The method as claimed in claim 26, wherein the containers pivot freely about a second pivot axle which pivot about the first pivot axle.
